(19) United States
(12) Patent Application Publication
(10) Pub. No.: US 2012/0243606 A1
(43) Pub. Date: Sep. 27, 2012

(54) METHODS, APPARATUSES AND COMPUTER PROGRAMS FOR VIDEO CODING

(75) Inventors: Jani LAINEMA, Tampere (FI); Kemal UGUR, Tampere (FI)

(73) Assignee: NOKIA CORPORATION, Espoo (FI)

(21) Appl. No.: 13/242,907

(22) Filed: Sep. 23, 2011

Related U.S. Application Data
(60) Provisional application No. 61/386,372, filed on Sep. 24, 2010.

(51) Int. Cl. H04N 7/26; H04N 7/30; H04N 7/32

(52) U.S. Cl. 375/240.12; 375/240.26; 375/240.18; 375/E07.226; 375/E07.243; 375/E07.093

(57) ABSTRACT

There is disclosed apparatuses, methods and computer programs for video coding. One or more subsets of a set of operations is determined; an operation among the operations within said subset of operations is selected; and an indication on the subset and on the selected operation is provided at the encoding. The decoding comprises determining one or more subsets of a set of operations; receiving a subset indication indicative of a selected subset among said one or more subsets and for receiving an operation indication indicative of an operation selected among operations within said selected subset; and selecting an operation on the basis of said operation indication.

### RELATED APPLICATION

This application claims priority to U.S. application Ser. No. 61/386,372 filed Sep. 24, 2010, which is incorporated herein by reference in its entirety.

### TECHNICAL FIELD

The present invention relates to an apparatus, a method and a computer program for encoding and decoding.

### BACKGROUND INFORMATION

A video codec may comprise an encoder which transforms input video into a compressed representation suitable for storage and/or transmission and a decoder that can uncompress the compressed video representation back into a viewable form, or either one of them. The encoder may discard some information in the original video sequence in order to represent the video in a more compact form, for example at a lower bit rate.

Many hybrid video codecs, operating for example according to the International Telecommunication Union's ITU-T H.263 and H.264 coding standards, encode video information in two phases. In the first phase, pixel values in a certain picture area or “block” are predicted. These pixel values can be predicted, for example, by motion compensation mechanisms, which involve finding and indicating an area in one of the previously encoded video frames (or a later coded video frame) that corresponds closely to the block being coded. Additionally, pixel values can be predicted by spatial mechanisms which involve finding and indicating a spatial region relationship.

Prediction approaches using image information from a previous (or a later) image can also be called as Inter prediction methods, and prediction approaches using image information within the same image can also be called as Intra prediction methods.

The second phase is one of coding the error between the predicted block of pixels and the original block of pixels. This is typically accomplished by transforming the difference in pixel values using a specified transform. This transform is typically a Discrete Cosine Transform (DCT) or a variant thereof. After transforming the difference, the transformed difference is quantized and entropy encoded.

By varying the fidelity of the quantization process, the encoder can control the balance between the accuracy of the pixel representation, (in other words, the quality of the picture) and the size of the resulting encoded video representation (in other words, the file size or transmission bit rate).

The decoder reconstructs the output video by applying a prediction mechanism similar to that used by the encoder in order to form a predicted representation of the pixel blocks (using the motion or spatial information created by the encoder and stored in the compressed representation of the image) and prediction error decoding (the inverse operation of the prediction error coding to recover the quantized prediction error signal in the spatial domain).

After applying pixel prediction and error decoding processes the decoder combines the prediction and the prediction error signals (the pixel values) to form the output video frame.

The decoder (and encoder) may also apply additional filtering processes in order to improve the quality of the output video before passing it for display and/or storing as a prediction reference for the forthcoming frames in the video sequence.

In typical video codecs, the motion information is indicated by motion vectors associated with each motion compensated image block. Each of these motion vectors represents the displacement of the image block in the picture to be coded (in the encoder) or decoded (at the decoder) and the prediction source block in one of the previously coded or decoded images (or pictures). In order to represent motion vectors efficiently, motion vectors are typically coded differentially with respect to block specific predicted motion vector. In a typical video codec, the predicted motion vectors are created in a predefined way, for example by calculating the median of the encoded or decoded motion vectors of the adjacent blocks.

In typical video codecs the prediction residual after motion compensation is first transformed with a transform kernel (like DCT) and then coded. The reason for this is that often there still exists some correlation among the residual and transform can in many cases help reduce this correlation and provide more efficient coding.

Typical video encoders utilize the Lagrangian cost function to find optimal coding modes, for example the desired macro block mode and associated motion vectors. This type of cost function uses a weighting factor or λ to tie together the exact or estimated image distortion due to lossy coding methods and the exact or estimated amount of information required to represent the pixel values in an image area.

This may be represented by the equation:

C=D+λR (1)

where C is the Lagrangian cost to be minimised, D is the image distortion (for example, the mean-squared error between the pixel values in original image block and in coded image block) with the mode and motion vectors currently considered, λ is a Lagrangian coefficient and R is the number of bits needed to represent the required data to reconstruct the image block in the decoder (including the amount of data to represent the candidate motion vectors).

Some hybrid video codecs, such as H.264/AVC, predict the Intra coded areas by spatial means utilizing the pixel values of the already processed areas in the picture. A typical codec has a fixed set of available prediction methods which provide predictions from the corresponding direction. If the number of available prediction directions is low, the compression performance may suffer as there may not be a method matching to all the directional structures in the picture content. If the number of available prediction directions is large the implementation complexity may become a burden. Some video codecs use a small number of directional intra prediction methods, for example from 2 to 8 different directions, which may lead into suboptimal performance but may keep the implementation complexity at a moderate level.

Many video codecs define subsets of coding tools (“profiles”) to be used in different use cases. This approach has the benefit of allowing different devices to implement the coding tools most appropriate for the intended usage and available resources on the implementation platform. But one drawback of this approach is the lost interoperability between different profiles of the codec.

Some general purpose video codecs, operating for example according to the International Telecommunication Union's ITU-T H.264/AVC coding standard, define a set of coding tools which can be applied during encoding of video in various ways resulting in different trade-offs between computational requirements and coding efficiency. Encoders may make at least some of these trade-offs to be able to perform the video encoding operation in a reasonable time in a non-real time environment or stronger trade-offs favoring e.g. limited computational resources especially in the case of real time video encoding. This kind of operation may lead to suboptimalities in the coding efficiency as the bitstream syntax may include codewords for operations that the encoder is not evaluating and thus will not exist in the generated bitstream.

Video encoders and decoders use the predefined alphabet of codewords representing the maximal allowed data set for each symbol in the bitstream.

### SUMMARY

The present invention introduces a method in which an alphabet of codewords for a set of symbols is modified to match a limited set of available codewords for each of these symbols. Information about the limitations to a set of codewords may be signaled in the bitstream and decoded in the video decoder. After decoding this piece of information, the video decoder may configure itself to use a limited set of codewords fulfilling the restrictions indicated.

In an example mode of operation a bitstream carries information about a set of allowed intra prediction directions for each prediction block size. This information may be carried in a sequence parameter set section of the bitstream which defines common parameters for the sequence of coded video frames. Further, in this example mode of operation, a default number of prediction directions is set to each available prediction block size and indication of whether this default number of prediction directions is used is signaled in the bitstream. In the case the default number of prediction directions is not used, additional information may be included in the bitstream to identify the actual number of allowed prediction directions.

According to a first aspect of the present invention there is provided an apparatus comprising:

one or more subsets of a set of operations;

a selector configured for selecting an operation among the operations within said subset of operations; and

an indication constructor configured for providing an indication on the subset and on the selected operation.

In some embodiments each subset includes a different number of operations, wherein said indication constructor is configured for providing the number of operations included in the subset as said indication on the subset.

The apparatus according to the first aspect may further comprise an alphabet of codewords assigned for each subset, wherein said indication constructor is configured for using a codeword of the alphabet assigned to the selected subset as said indication on the selected operation.

According to a second aspect of the present invention there is provided a method comprising:

determining one or more subsets of a set of operations;

selecting an operation among the operations within said subset of operations; and

providing an indication on the subset and on the selected operation.

According to a third aspect of the present invention there is provided a computer readable storage medium stored with code thereon for use by an apparatus, which when executed by a processor, causes the apparatus to perform:

determining one or more subsets of a set of operations;

selecting an operation among the operations within said subset of operations; and

providing an indication on the subset and on the selected operation.

According to a fourth aspect of the present invention there is provided at least one processor and at least one memory, said at least one memory stored with code thereon, which when executed by said at least one processor, causes an apparatus to perform:

determining one or more subsets of a set of operations;

selecting an operation among the operations within said subset of operations; and

providing an indication on the subset and on the selected operation.

According to a fifth aspect of the present invention there is provided an apparatus comprising:

one or more subsets of a set of operations;

an input for receiving a subset indication indicative of a selected subset among said one or more subsets and for receiving an operation indication indicative of an operation selected among operations within said selected subset; and

a selector for selecting an operation on the basis of said operation indication.

According to a sixth aspect of the present invention there is provided a method comprising:

determining one or more subsets of a set of operations;

receiving a subset indication indicative of a selected subset among said one or more subsets and for receiving an operation indication indicative of an operation selected among operations within said selected subset; and

selecting an operation on the basis of said operation indication.

According to a seventh aspect of the present invention there is provided a computer readable storage medium stored with code thereon for use by an apparatus, which when executed by a processor, causes the apparatus to perform:

determining one or more subsets of a set of operations;

receiving a subset indication indicative of a selected subset among said one or more subsets and for receiving an operation indication indicative of an operation selected among operations within said selected subset; and

selecting an operation on the basis of said operation indication.

According to an eighth aspect of the present invention there is provided at least one processor and at least one memory, said at least one memory stored with code thereon, which when executed by said at least one processor, causes an apparatus to perform:

determining one or more subsets of a set of operations;

receiving a subset indication indicative of a selected subset among said one or more subsets and for receiving an operation indication indicative of an operation selected among operations within said selected subset; and

selecting an operation on the basis of said operation indication.

According to a ninth aspect of the present invention there is provided an encoder comprising:

one or more subsets of a set of operations;

a selector configured for selecting an operation among the operations within said subset of operations; and

an indication constructor configured for providing an indication on the subset and on the selected operation.

According to a tenth aspect of the present invention there is provided a decoder comprising:

one or more subsets of a set of operations;

an input for receiving a subset indication indicative of a selected subset among said one or more subsets and for receiving an operation indication indicative of an operation selected among operations within said selected subset; and

a selector for selecting an operation on the basis of said operation indication.

According to an eleventh aspect of the present invention there is provided an apparatus comprising:

means for defining one or more subsets of a set of operations;

means for selecting an operation among the operations within said subset of operations; and

means for providing an indication on the subset and on the selected operation.

According to a twelfth aspect of the present invention there is provided an apparatus comprising:

means for defining one or more subsets of a set of operations;

means for receiving a subset indication indicative of a selected subset among said one or more subsets and for receiving an operation indication indicative of an operation selected among operations within said selected subset; and

means for selecting an operation on the basis of said operation indication.

According to a thirteenth aspect of the present invention there is provided an apparatus comprising:

one or more subsets of prediction modes, each prediction mode representing a directionality information for prediction;

a selector configured for selecting a prediction mode among the prediction modes within said subset of prediction modes; and

an indication constructor configured for providing a subset indication indicative of the subset and a prediction mode indication indicative of the selected prediction mode.

According to a fourteenth aspect of the present invention there is provided an apparatus comprising:

one or more subsets of prediction modes, each prediction mode representing a directionality information for prediction;

an input for receiving a subset indication indicative of a selected subset among said one or more subsets and for receiving a prediction mode indication indicative of a prediction mode selected among prediction modes within said selected subset; and

a selector for selecting an operation on the basis of said prediction mode indication.

The invention can be implemented in number of ways. For example, the maximum number of prediction directions does not have to depend on the prediction block size, but can be the same for all block sizes; the maximum number and signaling of the maximum number of prediction directions can depend on different other variables, such as the slice type (intra/inter slice), color plane information or quantization of the transform coefficients; the signaling of the maximum number of prediction directions can take place in different ways, e.g. it does not have to be part of the sequence parameter set, but can be e.g. signaled out of band; the set of actual intra prediction directions and their mapping into codewords can vary depending on the number of available prediction directions or other available information. The approach can also be applied to coding of different kind of data symbols instead or in addition to intra prediction directions, e.g. coding of the transform type in prediction error coding.

Some embodiments of the present invention allow low complexity video encoders to operate more efficiently by limiting the allowed alphabets for symbol elements to those that the encoder actually uses in the bitstream. This may result in bitrate savings as the mapping of symbols to codewords may become more optimal.

### DESCRIPTION OF THE DRAWINGS

For better understanding of the present invention, reference will now be made by way of example to the accompanying drawings in which:

FIG. 1 shows schematically an electronic device employing some embodiments of the invention;

FIG. 2 shows schematically a user equipment suitable for employing some embodiments of the invention;

FIG. 3 further shows schematically electronic devices employing embodiments of the invention connected using wireless and wired network connections;

FIG. 4a shows schematically an embodiment of the invention as incorporated within an encoder;

FIG. 4b shows schematically an embodiment of an intra predictor according to some embodiments of the invention;

FIG. 5 shows a flow diagram showing the operation of an embodiment of the invention with respect to the encoder as shown in FIG. 4a;

FIG. 6 shows a schematic diagram of a decoder according to some embodiments of the invention;

FIG. 7 shows a flow diagram of showing the operation of an embodiment of the invention with respect to the decoder shown in FIG. 6;

FIG. 8a depicts an example of available prediction directions for one mode of implementation;

FIG. 8b depicts an example of the horizontal mode in which pixel values for a current block are predicted by using pixel values of the neighboring block in the horizontal direction;

FIG. 8c depicts an example of the vertical mode in which pixel values for a current block are predicted by using pixel values of the neighboring block in the vertical direction;

FIG. 8d depicts an example of predicting one row of pixels in a block from reference pixels, when the displacement between the lowest row of the block and the reference row is negative;

FIG. 8e depicts an example of obtaining prediction values for pixels from a block from reference pixels according to another embodiment; and

FIG. 9 depicts an example of a bit stream of an image.

### DETAILED DESCRIPTION OF SOME EXAMPLE EMBODIMENTS

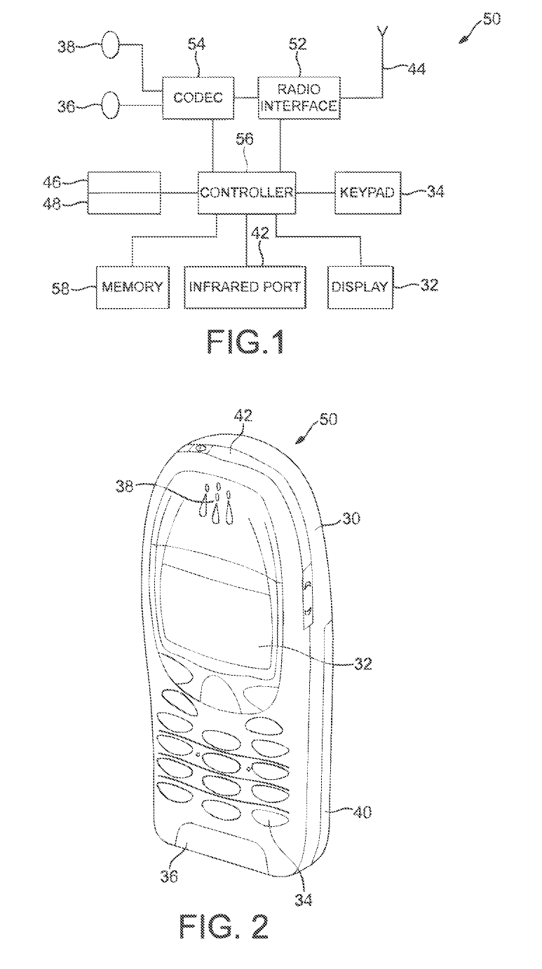

The following describes in further detail suitable apparatus and possible mechanisms for the provision of reducing information to be transmitted in video coding systems and more optimal codeword mappings in some embodiments. In this regard reference is first made to FIG. 1 which shows a schematic block diagram of an exemplary apparatus or electronic device 50, which may incorporate a codec according to an embodiment of the invention.

The electronic device 50 may for example be a mobile terminal or user equipment of a wireless communication system. However, it would be appreciated that embodiments of the invention may be implemented within any electronic device or apparatus which may require encoding and decoding or encoding or decoding video images.

The apparatus 50 may comprise a housing 30 for incorporating and protecting the device. The apparatus 50 further may comprise a display 32 in the form of a liquid crystal display. In other embodiments of the invention the display may be any suitable display technology suitable to display an image or video. The apparatus 50 may further comprise a keypad 34. In other embodiments of the invention any suitable data or user interface mechanism may be employed. For example the user interface may be implemented as a virtual keyboard or data entry system as part of a touch-sensitive display. The apparatus may comprise a microphone 36 or any suitable audio input which may be a digital or analogue signal input. The apparatus 50 may further comprise an audio output device which in embodiments of the invention may be any one of: an earpiece 38, speaker, or an analogue audio or digital audio output connection. The apparatus 50 may also comprise a battery 40 (or in other embodiments of the invention the device may be powered by any suitable mobile energy device such as solar cell, fuel cell or clockwork generator). The apparatus may further comprise an infrared port 42 for short range line of sight communication to other devices. In other embodiments the apparatus 50 may further comprise any suitable short range communication solution such as for example a Bluetooth wireless connection or a USB/firewire wired connection.

The apparatus 50 may comprise a controller 56 or processor for controlling the apparatus 50. The controller 56 may be connected to memory 58 which in embodiments of the invention may store both data in the form of image and audio data and/or may also store instructions for implementation on the controller 56. The controller 56 may further be connected to codec circuitry 54 suitable for carrying out coding and decoding of audio and/or video data or assisting in coding and decoding carried out by the controller 56.

The apparatus 50 may further comprise a card reader 48 and a smart card 46, for example a UICC and UICC reader for providing user information and being suitable for providing authentication information for authentication and authorization of the user at a network.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 44 connected to the radio interface circuitry 52 for transmitting radio frequency signals generated at the radio interface circuitry 52 to other apparatus(es) and for receiving radio frequency signals from other apparatus(es).

In some embodiments of the invention, the apparatus 50 comprises a camera capable of recording or detecting individual frames which are then passed to the codec 54 or controller for processing. In some embodiments of the invention, the apparatus may receive the video image data for processing from another device prior to transmission and/or storage. In some embodiments of the invention, the apparatus 50 may receive either wirelessly or by a wired connection the image for coding/decoding.

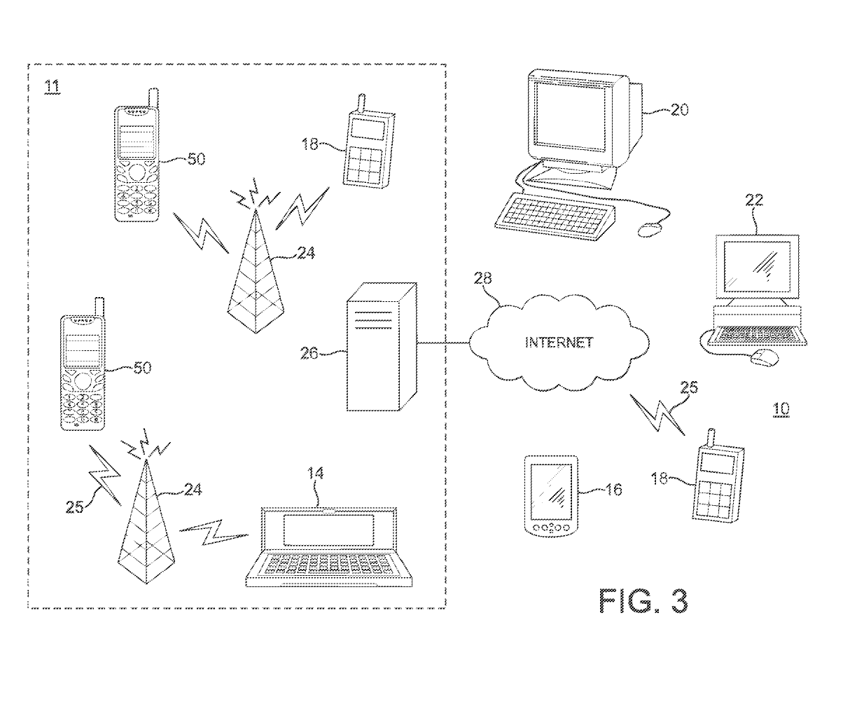

With respect to FIG. 3, an example of a system within which embodiments of the present invention can be utilized is shown. The system 10 comprises multiple communication devices which can communicate through one or more networks. The system 10 may comprise any combination of wired or wireless networks including, but not limited to a wireless cellular telephone network (such as a GSM, UMTS, CDMA network etc), a wireless local area network (WLAN) such as defined by any of the IEEE 802.x standards, a Bluetooth personal area network, an Ethernet local area network, a token ring local area network, a wide area network, and the Internet.

The system 10 may include both wired and wireless communication devices or apparatus 50 suitable for implementing embodiments of the invention.

For example, the system shown in FIG. 3 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an electronic device or apparatus 50, a combination of a personal digital assistant (PDA) and a mobile telephone 14, a PDA 16, an integrated messaging device (IMD) 18, a desktop computer 20, a notebook computer 22. The apparatus 50 may be stationary or mobile when carried by an individual who is moving. The apparatus 50 may also be located in a mode of transport including, but not limited to, a car, a truck, a taxi, a bus, a train, a boat, an airplane, a bicycle, a motorcycle or any similar suitable mode of transport.

Some or further apparatus may send and receive calls and messages and communicate with service providers through a wireless connection 25 to a base station 24. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11 and any similar wireless communication technology. A communications device involved in implementing various embodiments of the present invention may communicate using various media including, but not limited to, radio, infrared, laser, cable connections, and any suitable connection.

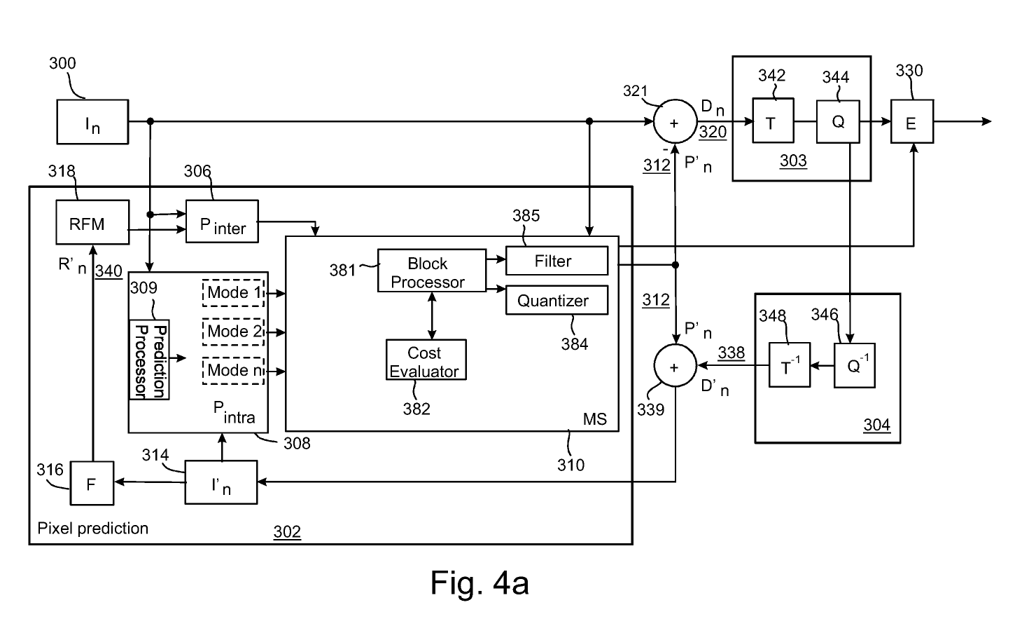

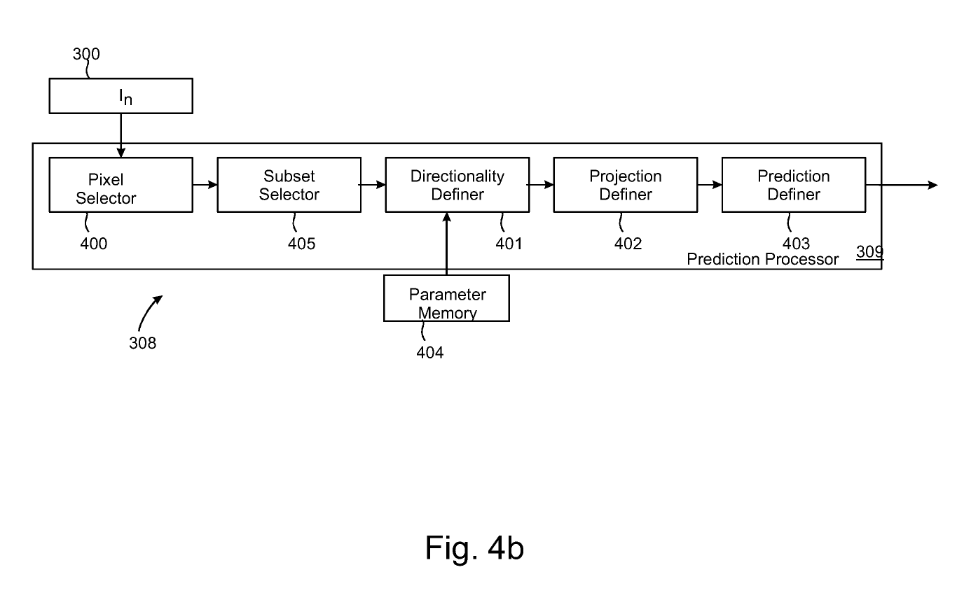

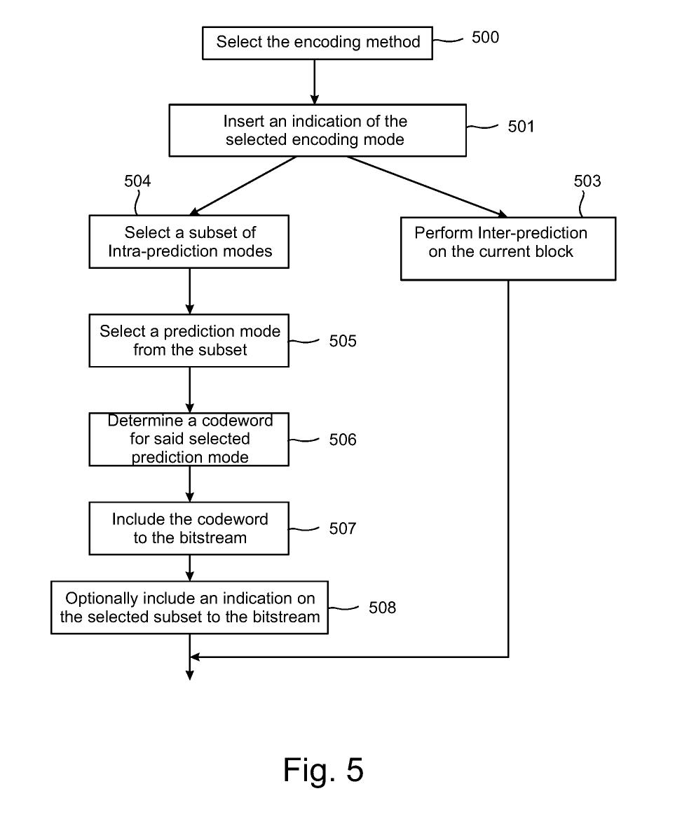

With respect to FIG. 4a, a block diagram of a video encoder suitable for carrying out embodiments of the invention is shown. Furthermore, with respect to FIG. 5, the operation of the encoder exemplifying embodiments of the invention specifically with respect to the selection of a subset of prediction modes and providing an indication of a selected prediction mode in the selected subset is shown as a flow diagram.

FIG. 4a shows the encoder as comprising a pixel predictor 302, prediction error encoder 303 and prediction error decoder 304. FIG. 4a also shows an embodiment of the pixel predictor 302 as comprising an inter-predictor 306, an intra-predictor 308, a mode selector 310, a filter 316, and a reference frame memory 318. The mode selector 310 comprises a block processor 381 and a cost evaluator 382. FIG. 4b also depicts an embodiment of the intra-predictor 308 which comprises a plurality of subsets S1, S2, S3 of different intra-prediction modes Mode 1, Mode 2, . . . , Mode n and may also comprise a prediction processor 309. The mode selector 310 may also comprise a quantizer 384.

The pixel predictor 302 receives the image 300 to be encoded at both the inter-predictor 306 (which determines the difference between the image and a motion compensated reference frame 318) and the intra-predictor 308 (which determines a prediction for an image block based only on the already processed parts of current frame or picture). The output of both the inter-predictor and the intra-predictor are passed to the mode selector 310. The intra-predictor 308 may have more than one intra-prediction modes. Hence, each mode may perform the intra-prediction and provide the predicted signal to the mode selector 310. The mode selector 310 also receives a copy of the image 300.

The block processor 381 determines which encoding mode to use to encode the current block. If the block processor 381 decides to use an inter-prediction mode it will pass the output of the inter-predictor 306 to the output of the mode selector 310. If the block processor 381 decides to use an intra-prediction mode it will pass the output of one of the intra-predictor modes to the output of the mode selector 310.

According to some example embodiments the pixel predictor 302 operates as follows. The inter predictor 306 and the intra prediction modes 308 perform the prediction of the current block to obtain predicted pixel values of the current block. The inter predictor 306 and the intra prediction modes 308 may provide the predicted pixel values of the current block to the block processor 381 for analyzing which prediction to select. In addition to the predicted values of the current block, the block processor 381 may, in some embodiments, receive an indication of a directional intra prediction mode from the intra prediction modes.

The block processor 381 examines whether to select the inter prediction mode or the intra prediction mode. The block processor 381 may use cost functions such as the equation (1) or some other methods to analyze which encoding method gives the most efficient result with respect to a certain criterion or criteria. The selected criteria may include coding efficiency, processing costs and/or some other criteria. The block processor 381 may examine the prediction for each directionality i.e. for each intra prediction mode and inter prediction mode and calculate the cost value for each intra prediction mode and inter prediction mode, or the block processor 381 may examine only a subset of all available prediction modes in the selection of the prediction mode.

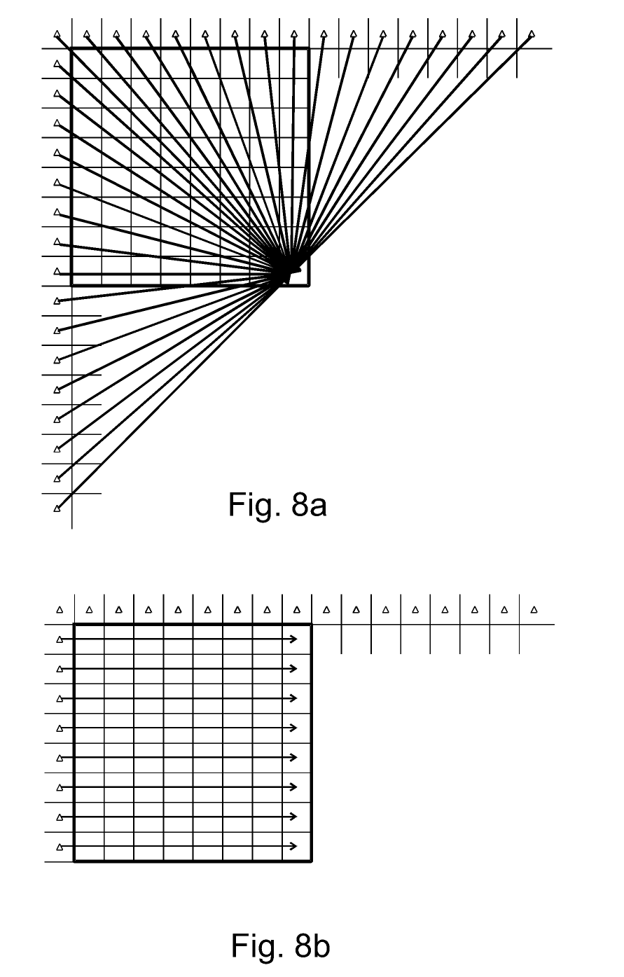

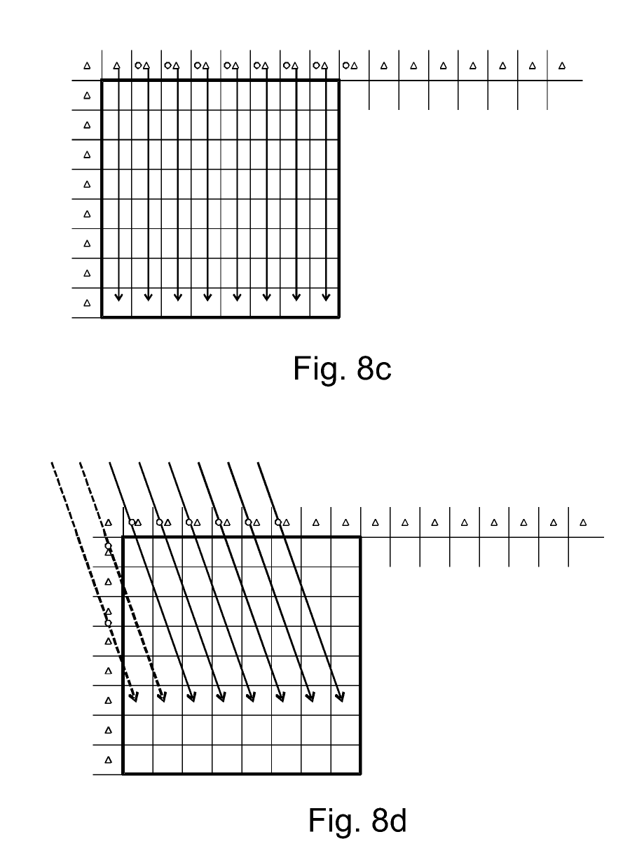

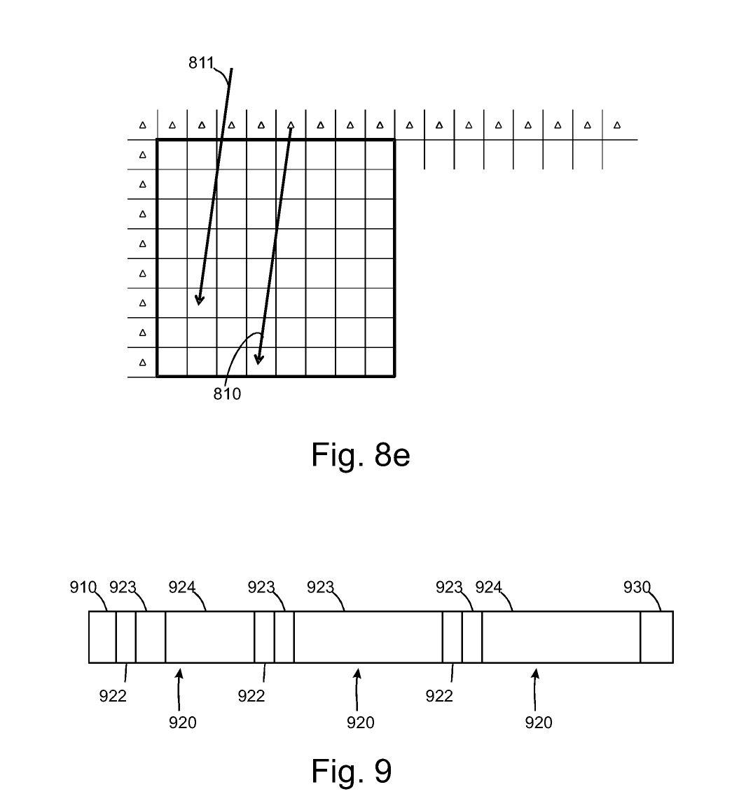

In some embodiments, the available intra prediction modes include a horizontal mode, a vertical mode, a number of diagonal modes and a DC mode. In the horizontal mode pixel values for a current block are predicted by using pixel values of the neighboring block in the horizontal direction e.g. the neighboring block on the left side of the current block. An example of this is illustrated in FIG. 8b. In the vertical mode pixel values for a current block are predicted by using pixel values of the neighboring block in the vertical direction e.g. the neighboring block above the current block. An example of this is illustrated in FIG. 8c. In the diagonal mode pixel values for a current block are predicted by using pixel values of the neighboring block in a “diagonal” direction. Some examples of this situation are illustrated in FIGS. 8d and 8e.

In some embodiments there may be even tenths of available prediction modes, for example over 40 different prediction modes.

An example of allowed displacements is illustrated in FIG. 8a in which the directionality is analyzed with respect to the current block. The displacement is expressed with reference to the last pixel at the last row of the block but it can also be expressed with reference to another pixel of the same block. The lines from the last pixel of the last row to different pixels of the neighboring blocks illustrate the allowed directions (displacements) in this example embodiment. These pixels of the neighboring blocks can be used as reference pixels for prediction of pixels of the current block. The reference pixels are indicated as triangles in FIG. 8a. In this example the block size is 8×8 and the range is from −N to +N, wherein the displacement can be from −8 to +8 pixels with one pixel resolution. In some other embodiments the difference between two consecutive, allowed displacements can be a fraction of one pixel, for example ½ pixels wherein there are more directions to select from.

In some embodiments the block processor 381 or another element of the encoder may determine to use only a subset of available intra prediction modes when the block processor 381 performs the prediction for the current block. In some embodiments there are nine different prediction modes from which one prediction mode can be selected. The prediction modes indicate the prediction directions on the basis of which the block processor 381 may determine which pixel values of a neighboring block of the current block to use in prediction of pixel values of the current block. In an example embodiment, for a block size of 4×4 samples, Mode 0 corresponds with a vertical prediction direction, Mode 1 corresponds with a horizontal prediction direction, Modes 3 to Mode 8 correspond with different diagonal directions, and Mode 2 corresponds with a prediction based on values of adjacent samples (DC prediction).

For example, if there were nine prediction modes Mode 0, Mode 1, . . . , Mode 8 from which one prediction mode could be selected, the block processor 381 may only use e.g. every other mode (for examples Mode 1, Mode 3, . . . , Mode 7 or Mode 0, Mode 2, . . . , Mode 8) and select the prediction mode for the current block among the modes of that subset. However, in some other embodiments the subset of the modes could also be different from the above. The encoder may provide an indication of the subset of the selectable modes to the decoder so that the decoder is aware of the modes from which the selection has been made. In addition to the indication of the subset, the encoder provides an indication of the selected mode to the decoder. In some example embodiments the indication of the subset of the available modes is provided in a sequence parameter set. However, the indication of the subset need not be provided in the same bitstream than the prediction information but it can also be provided by using another bitstream or other means of communication.

The selection of the available modes may or may not depend on the block size. There can also be a default subset of modes wherein the encoder could indicate the decoder whether the default subset of modes is used or if another subset of modes is used. Hence, if another subset is used, the encoder could provide additional information on the subset of modes. In some embodiments it is not necessary to indicate that the default subset of modes is used but the decoder uses the default subset of modes unless otherwise indicated e.g. by the encoder.

In some embodiments a default subset of modes may have been assigned for each available block size. Hence, the encoder could indicate the decoder the block size of the current block and whether the default subset of modes is used. If another subset of modes is used the encoder could provide additional information on the subset of modes.

In some embodiments there can be a selection of subsets of prediction modes and each subset may be provided by a subset index or other indication of the subset. Using the example above there could be a first subset which comprises the odd numbered modes (Mode 1, Mode 3, . . . , Mode 7) and a second subset which comprises the even numbered modes (Mode 0, Mode 2, . . . , Mode 8). There could also be third subset containing modes Mode 0, Mode 1, Mode 3, and Mode 4, a fourth subset containing modes Mode 5, Mode 6, Mode 7, and Mode 8, and a fifth subset containing Mode 2. The first subset could be assigned a first subset index, the second subset could be assigned a second subset index etc. The relationship between the modes in the subsets and the subset indices are also provided in the decoder. Hence, the subset index indicates to the decoder which modes have been used in the selection of the prediction mode. The decoder also receives an indication of the selected mode in the subset (mode index). Therefore, the decoder may use both the subset indication and the indication of the mode to determine the mode the encoder has used in the prediction of the current block. The mode index may be signaled e.g. in a prediction unit element of the encoded video bitstream. The subset of the prediction modes may not change between macroblocks of the same picture. In such a situation, the subset need not be signaled to the decoder for each macroblock but it may suffice to only signal the subset for each slice, picture, group of pictures or once for the same video presentation. The method the subset indication is signaled to the decoder may change accordingly so that the signaling would not unnecessarily load the communication channel.

In some other embodiments the block processor 381 may determine a smaller number of prediction modes to be used in the block prediction than the total number of available prediction modes. For example, if the total number of available prediction modes is nine, the block processor may decide to perform the selection among e.g. four prediction modes, or among another number of prediction modes less than the total number of available prediction modes. This number of prediction modes can also be called as a maximum number of prediction modes. It should be noted here that the term maximum does not refer to the total number of available prediction modes (unless the block processor 381 has selected to perform the selection of the prediction modes among all available prediction modes. In other words, the maximum number of prediction modes is usually smaller than the total number of prediction modes.

In some embodiments the block processor 381 may be allowed to select any possible number between one and the total number of available prediction modes whereas in some other embodiments the block processor 381 may not be allowed to select any of the possible numbers but only some of them. For example, the block processor 381 may be limited to select only even numbers of available prediction modes i.e. two, four, six, etc. prediction modes to be used in the block prediction.

In some embodiments the selected (maximum) number directly indicates which prediction modes are included in the subset of prediction modes from which the block processor 381 may select the prediction mode for the current block.

When the cost has been calculated with respect to each or to a selected set of intra prediction modes and possibly with respect to the inter prediction mode, the block processor 381 selects one intra prediction mode or the inter prediction mode for encoding the current block. If an intra prediction mode was selected, the selected intra prediction mode includes the directionality indication which shall also be indicated to a decoder.

When the block processor 381 has selected to use an intra prediction mode, and selected, when necessary, the appropriate number of prediction modes to be used in the prediction of the current block, the block processor 381 determines which prediction mode to use in the prediction. The selected prediction mode is then signaled to the decoder. The signaling may be performed by determining a codeword from an alphabet of codewords on the basis of the selected prediction method. There may be different alphabets of codewords for different numbers of available prediction modes. Different alphabets could contain similar codewords but the meaning of similar codewords could differ from one alphabet to another alphabet.

As an example, let us assume that there is a first subset of available prediction modes, which contains a first number V of available prediction modes (e.g. Mode 1, . . . , Mode V), and a second subset of available prediction modes, which contains a second number W of available prediction modes (e.g. Mode 1, . . . , Mode W). There could also be a first alphabet of codewords containing the first number V of codewords (CV₁, . . . , CV_{V}) each representing one prediction mode of the first subset, and a second alphabet of codewords containing the second number W of codewords (CW₁, . . . , CW_{W}) each representing one prediction mode of the second subset. If the block processor 381 has used the first number V of available prediction modes and selected the second prediction mode from that subset, the block processor 381 may use the first alphabet of codewords to find the correct codeword for the selected prediction mode. In this example the block processor 381 would select the second code word i.e. CV₂. This codeword is then added to the bitstream.

In some situations the block processor 381 may decide to use all available prediction modes (e.g. Mode 1, . . . , Mode Z, in which Z>V and Z>W) from which one prediction mode is selected. Hence, a third alphabet of codewords comprising a third number Z of codewords (CV₁, . . . , CV_{Z}) may be needed to indicate the decoder which prediction mode has been selected.

It can be deduced that when the third number Z is greater than the first number V and the second number W, also more codewords are needed in the third alphabet. This may mean that some of the codewords of the third alphabet are longer than the codewords in the first and the second alphabet when a variable length coding (VLC) is used in designing the alphabets of codewords. For example, let us assume that the first alphabet comprises codewords 00, 10, 010, 011; the second alphabet comprises the same codewords (but at least some of them assigned to different modes); and the third alphabet comprises codewords 00, 10, 0100, 0110, 010100, 010101, 011100, 011101. It can be seen that the average length of the codewords is smaller in the first and the second alphabet than in the third alphabet. Hence, if the encoder only uses a subset of all the available prediction modes, some savings in the bitrate can be achieved when using the above described embodiments of the present invention.

In addition to or instead of the variable length coding, the codewords may be based on to another coding method, for example they may be designed using arithmetic coding. In some further embodiments two or more different coding methods may be used in the selection of codewords. For example, some alphabets of codewords may be based on VLC coding and some other alphabets may be based on arithmetic coding. In such a case an indication of the coding method may need to be provided to the decoder either in the bitstream or as a parameter in the decoder or by another appropriate method.

As was mentioned above, the selection of the number of available prediction modes need not be performed for each block, for each slice, for for each picture, or for each group of pictures, wherein indication of the number of prediction modes need not be signaled for each block but e.g. only when the number of the available prediction mode changes.

In some example embodiments the number of available prediction modes may change if the block size changes. However, if a default number of available prediction modes is provided, the encoder may not need to indicate the actual number of available prediction modes to the decoder but the decoder is aware of what number of available prediction modes to use unless otherwise indicated.

It is also possible that the block processor 381 does not examine for each block which subset to use but the examining may be performed less often. In such situations the block processor 381 may calculate the cost for only such prediction modes which are included in the (previously) selected subset of available prediction modes. In some other embodiments

Although the description above indicated that the encoder, or the block processor 381 of the encoder, selects a subset of available prediction modes, the present invention can also be implemented in connection with video coding systems in which the encoder only uses one subset of the available prediction modes. Hence, there is no need to perform the selection of the subset but only the selection of the prediction mode among the prediction modes of the subset when the block processor 381 has selected to use the intra prediction to encode the current block. In this case the encoder may signal indication on the subset it uses to the decoder in the beginning of a video stream, for example.

The indication of a directional intra prediction mode may comprise an angle indicated, for example, as a displacement of one row of the current block with respect to a reference row of pixels of a neighboring block in case of vertical prediction or as a displacement of one column of the current block with respect to a reference column of pixels of a neighboring block in case of horizontal prediction. In some embodiments the allowed displacements in the horizontal and vertical direction may depend on the size of the block to be encoded. Some example ranges are from −N to +N pixels for a block size of N×N pixels for both horizontal and vertical prediction. Other example ranges are −2N×+2N pixels, −3N×+3N pixels, −2N×+4N pixels, −4N×+2N pixels, etc. The angle may also be indicated by using other means, for example as an integer value, a floating point number, etc.

The same or different intra prediction direction can be applied for different components of the picture block (such as luminance, chrominance or depth component), or the indication of the intra prediction direction for one or more components can be used to limit the allowed set of intra prediction directions of one or more other components.

The predicted pixel values or predicted pixel values quantized by the optional quantizer 384 are provided as the output of the mode selector.

The output of the mode selector is passed to a first summing device 321. The first summing device may subtract the pixel predictor 302 output from the image 300 to produce a first prediction error signal 320 which is input to the prediction error encoder 303.

The pixel predictor 302 further receives from a preliminary reconstructor 339 the combination of the prediction representation of the image block 312 and the output 338 of the prediction error decoder 304. The preliminary reconstructed image 314 may be passed to the intra-predictor 308 and to a filter 316. The filter 316 receiving the preliminary representation may filter the preliminary representation and output a final reconstructed image 340 which may be saved in a reference frame memory 318. The reference frame memory 318 may be connected to the inter-predictor 306 to be used as the reference image against which the future image 300 is compared in inter-prediction operations.

The operation of the pixel predictor 302 may be configured to carry out any known pixel prediction algorithm known in the art.

The pixel predictor 302 may also comprise a filter 385 to filter the predicted values before outputting them from the pixel predictor 302.

The operation of the prediction error encoder 302 and prediction error decoder 304 will be described hereafter in further detail. In the following examples the encoder generates images in terms of 16×16 pixel macroblocks which go to form the full image or picture. Thus, for the following examples the pixel predictor 302 outputs a series of predicted macroblocks of size 16×16 pixels and the first summing device 321 outputs a series of 16×16 pixel residual data macroblocks which may represent the difference between a first macro-block in the image 300 against a predicted macro-block (output of pixel predictor 302). It would be appreciated that other size macro blocks may be used.

The prediction error encoder 303 comprises a transform block 342 and a quantizer 344. The transform block 342 transforms the first prediction error signal 320 to a transform domain. The transform is, for example, the DCT transform. The quantizer 344 quantizes the transform domain signal, e.g. the DCT coefficients, to form quantized coefficients.

The entropy encoder 330 receives the output of the prediction error encoder and may perform a suitable entropy encoding/variable length encoding on the signal to provide error detection and correction capability. Any suitable entropy encoding algorithm may be employed.

The prediction error decoder 304 receives the output from the prediction error encoder 303 and performs the opposite processes of the prediction error encoder 303 to produce a decoded prediction error signal 338 which when combined with the prediction representation of the image block 312 at the second summing device 339 produces the preliminary reconstructed image 314. The prediction error decoder may be considered to comprise a dequantizer 346, which dequantizes the quantized coefficient values, e.g. DCT coefficients, to reconstruct the transform signal and an inverse transformation block 348, which performs the inverse transformation to the reconstructed transform signal wherein the output of the inverse transformation block 348 contains reconstructed block(s). The prediction error decoder may also comprise a macroblock filter (not shown) which may filter the reconstructed macroblock according to further decoded information and filter parameters.

The operation and implementation of the mode selector 310 is shown in further detail with respect to FIG. 5. On the basis of the prediction signals from the output of the inter-predictor 306, the output of the intra-predictor 308 and/or the image signal 300 the block processor 381 determines which encoding mode to use to encode the current image block. This selection is depicted as the block 500 in FIG. 5. The block processor 381 may calculate a rate-distortion cost (RD) value or another cost value for the prediction signals which are input to the mode selector 310 and select such an encoding mode 503, 504 for which the determined cost is the smallest.

The mode selector 310 provides an indication of the encoding mode of the current block (501). The indication may be encoded and inserted to a bit stream or stored into a memory together with the image information. In connection with the intra prediction modes it may be necessary to include some indication of the selected intra prediction mode to the bit stream. For example, the indication may include information on the directionality of the intra prediction mode. In some example embodiments the information on the directionality is indicated as a displacement value. In some embodiments the displacement value indicates which reference value is used to obtain the prediction value of the last pixel of the last row of the current block. In some other embodiments the angular coefficient of the directionality is included in the bit stream. In yet another embodiments the allowed directionality values (intra prediction modes) are indexed and the index of the selected intra prediction mode is included in the bit stream.

The indication may not be included in the bit stream as such but it may also be encoded e.g. by entropy encoding. The prediction direction can also be entropy coded in a predictive manner considering used prediction directions in the image block's neighborhood, statistics of earlier prediction directions or other variables.

If the intra-prediction mode is selected, the block is predicted by an intra-prediction method (504-508). Respectively, if the inter-prediction mode is selected, the block is predicted by an inter-prediction method (503).

In the intra-prediction method the block processor 381 optionally selects a subset of available prediction modes. This selection is depicted as the block 504 in FIG. 5. The block processor 381 also selects 505 one prediction mode among the prediction modes included in the (selected) subset. The block processor 381 also determines the codeword to indicate the selected prediction mode by using an alphabet of codeword which corresponds with the selected subset of prediction modes (506). The codeword is included in the bitstream (507). Also an indication of the selected subset may be included in the bitstream (508), if necessary. FIG. 4b depicts the intra predictor 308 of an example embodiment of the encoder in more detail. The intra predictor 308 may be implemented in a prediction processor 309 or as another circuitry. The prediction processor 309 may be a separate processor or it may be the same processor than the block processor 381. The intra predictor 308 comprises a pixel selector 400 to select the pixel to be predicted. There is also a subset selector 405 which may select the subset of intra prediction modes, and a directionality definer 401 which determines the directionality of the prediction mode among the intra prediction modes of the selected subset which shall be used to predict the value for the selected pixel. The directionality definer 401 may receive some parameters from the parameter memory 404. When the directionality has been determined the projection definer 402 defines the projection of the selected pixel to the set of reference pixels. The projection definer 402 may also receive some parameters from the parameter memory 404. The intra predictor 308 may further comprise a prediction definer 403 which uses the information from the projection definer and the set of reference pixels to determine the prediction value for the selected pixel. The intra predictor 308 may repeat some or all the above steps to define prediction values for all pixels of the block. The directionality need not be determined for each pixel of one block because in some embodiments the same directionality is used for each pixel of one block.

In an example embodiment, as is depicted in FIG. 9, the bit stream of an image comprises an indication of the beginning of an image 910, image information of each block of the image 920, and indication of the end of the image 930. The image information of each block of the image 920 may include the indication of the prediction mode 922, indication of the directionality 923, and the indication of pixel values of the block 924 which may actually include coefficients of the residual signal when the inter- or intra-prediction has been used for the image block. It is obvious that the bit stream may also comprise other information. Further, this is only a simplified image of the bit stream and in practical implementations the contents of the bit stream may be different from what is depicted in FIG. 9.

The bit stream may further be encoded by the entropy encoder 330.

Although the embodiments above have been described with respect to the size of the macroblock being 16×16 pixels, it would be appreciated that the methods and apparatus described may be configured to handle macroblocks of different pixel sizes.

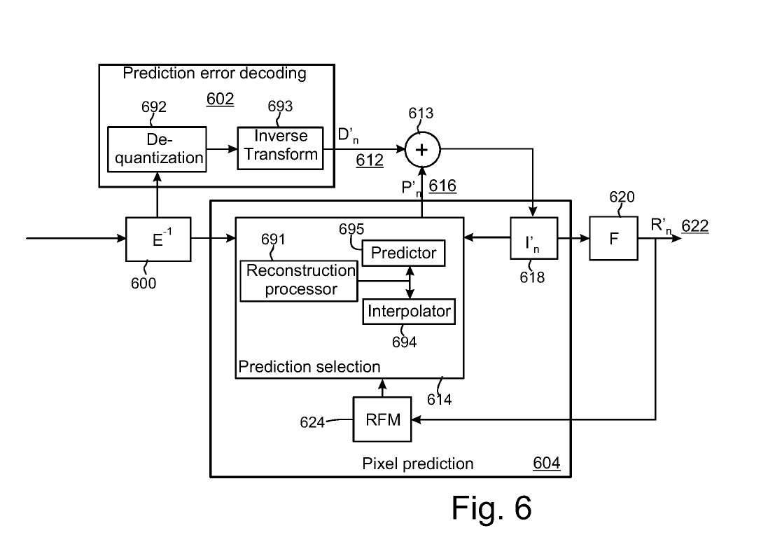

In the following the operation of an example embodiment of the decoder 600 is depicted in more detail with reference to FIG. 6.

For completeness a suitable decoder is hereafter described. At the decoder side similar operations are performed to reconstruct the image blocks. FIG. 6 shows a block diagram of a video decoder suitable for employing embodiments of the invention. The decoder shows an entropy decoder 600 which performs an entropy decoding on the received signal. The entropy decoder thus performs the inverse operation to the entropy encoder 330 of the encoder described above. The entropy decoder 600 outputs the results of the entropy decoding to a prediction error decoder 602 and pixel predictor 604.

The pixel predictor 604 receives the output of the entropy decoder 600. The output of the entropy decoder 600 may include an indication on the prediction mode used in encoding the current block. A predictor selector 614 within the pixel predictor 604 determines that an intra-prediction, an inter-prediction, or interpolation operation is to be carried out. The predictor selector may furthermore output a predicted representation of an image block 616 to a first combiner 613. The predicted representation of the image block 616 is used in conjunction with the reconstructed prediction error signal 612 to generate a preliminary reconstructed image 618. The preliminary reconstructed image 618 may be used in the predictor 614 or may be passed to a filter 620. The filter 620 applies a filtering which outputs a final reconstructed signal 622. The final reconstructed signal 622 may be stored in a reference frame memory 624, the reference frame memory 624 further being connected to the predictor 614 for prediction operations.

In the case of intra-prediction the pixel predictor 604 may also receive indication on the subset of the intra prediction modes which the encoder has used when selecting the intra prediction mode. This indication may be have been previously received from the encoder, wherein a parameter in the decoder indicative of the subset may have been set to a corresponding value so that the pixel predictor 604 may use the value of the parameter in determining the correct subset. In some other embodiments the indication on the subset of the intra prediction mode may be received in the bitstream during the reception of the bitstream containing encoded video information.

The prediction error decoder 602 receives the output of the entropy decoder 600. A dequantizer 692 of the prediction error decoder 602 may dequantize the output of the entropy decoder 600 and the inverse transform block 693 may perform an inverse transform operation to the dequantized signal output by the dequantizer 692. The output of the entropy decoder 600 may also indicate that prediction error signal is not to be applied and in this case the prediction error decoder produces an all zero output signal.

The decoder selects the 16×16 pixel residual macroblock to reconstruct. The selection of the 16×16 pixel residual macroblock to be reconstructed is shown in step 700.

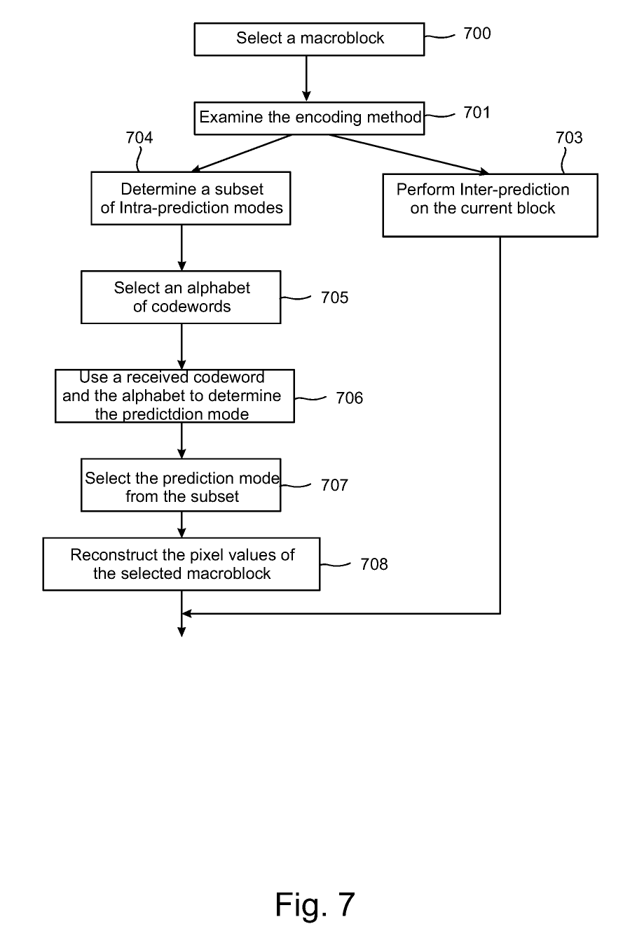

The decoder receives information on the encoding mode used when the current block has been encoded. The indication is decoded, when necessary, and provided to the reconstruction processor 691 of the prediction selector 614. The reconstruction processor 691 examines the indication (block 701 in FIG. 7) and selects one of the intra-prediction modes (block 704-708), if the indication indicates that the block has been encoded using intra-prediction, inter-prediction mode (block 703), if the indication indicates that the block has been encoded using inter-prediction.

If the current block has been encoded using intra-prediction, the pixel predictor 604 determines the subset of the intra prediction modes (block 704) which the encoder has used in the encoding process. By using this information on the subset, the pixel predictor 604 selects the corresponding alphabet of codewords which have been used in encoding the indication on the selected prediction mode (block 705). Hence, the pixel predictor 604 may be aware of the maximum length of codewords in the alphabet and can use this information, if necessary, when it converts a received codeword into an indication on the intra prediction mode (block 706). For example, if the maximum length of the codewords is five, the pixel predictor 604 or another element in the decoder may determine that it needs to use only five bits or less to determine the codeword. The determination of the codeword can be based on look-up tables, for example.

The pixel predictor 604 uses the decoded indication of the intra prediction mode to select the prediction mode for the decoding of pixel values of the current block (block 707).

When the pixel predictor 604 has determined the intra prediction mode of the current block, the reconstruction processor 691 can begin to decode the prediction values of the pixel values of the current block and reconstruct pixel values on the basis of already decoded and reconstructed pixel values of neighboring blocks. The prediction mode indicates which pixel values to use in the reconstruction of pixel values of the current block. In addition to the prediction values the reconstruction processor 691 may use prediction error information which may have been included in the bitstream to provide the prediction values of the current block (block 708).

In the intra-prediction mode the reconstruction processor 691 may provide the preliminary reconstructed image 618 to the predictor block 695 for reconstruction of the pixel values of the current block.

The present invention may also be applicable to some other parts of a video coding system. For example, video coding system may be able to select a transform type among a number of transform types to be used in prediction error coding. The encoder may use only a subset of the available transform types and provide an indication on the subset of transform types and the transform type selected from the subset to the decoder. In the provision of the indication of the subset and on the selected transform type similar approaches as disclosed above can be implemented.

As a generalization there may also be some other sets of operations relating to video coding which can be arranged into one or more subsets of operations, wherein a selection of a subset of operations and a selection of an operation within the selected subset may be performed. Hence, indications may be provided by using the above disclosed principles.

The embodiments of the invention described above describe the codec in terms of separate encoder and decoder apparatus in order to assist the understanding of the processes involved. However, it would be appreciated that the apparatus, structures and operations may be implemented as a single encoder-decoder apparatus/structure/operation. Furthermore in some embodiments of the invention the coder and decoder may share some or all common elements.

Although the above examples describe embodiments of the invention operating within a codec within an electronic device, it would be appreciated that the invention as described below may be implemented as part of any video codec. Thus, for example, embodiments of the invention may be implemented in a video codec which may implement video coding over fixed or wired communication paths.

Thus, user equipment may comprise a video codec such as those described in embodiments of the invention above.

It shall be appreciated that the term user equipment is intended to cover any suitable type of wireless user equipment, such as mobile telephones, portable data processing devices or portable web browsers.

Furthermore elements of a public land mobile network (PLMN) may also comprise video codecs as described above.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

An apparatus according to a first embodiment comprises:
one or more subsets of a set of operations;
a selector configured for selecting an operation among the operations within said subset of operations; and
an indication constructor configured for providing an indication on the subset and on the selected operation.

In some embodiments each subset includes a different number of operations, wherein said indication constructor is configured for providing the number of operations included in the subset as said indication on the subset.

The apparatus of the first embodiment may further comprise an alphabet of codewords assigned for each subset, wherein said indication constructor is configured for using a codeword of the alphabet assigned to the selected subset as said indication on the selected operation.

In some embodiments said codewords are variable length codewords.

In some embodiments said codewords are based on arithmetic coding.

In the apparatus of the first embodiment of the invention the set of operations may comprise a set of different prediction modes, each prediction mode representing a prediction directionality.

In the apparatus of the first embodiment of the invention the set of operations may comprise a set of different transform types.

In some embodiments said transform types are for prediction error coding.

A method according to a second embodiment comprises:

determining one or more subsets of a set of operations;

selecting an operation among the operations within said subset of operations; and

providing an indication on the subset and on the selected operation.

In some embodiments of the method each subset includes a different number of operations, wherein the method comprises providing the number of operations included in the subset as said indication on the subset.

The method according to the second embodiment may further comprise assigning an alphabet of codewords for each subset, and using a codeword of the alphabet assigned to the selected subset as said indication on the selected operation.

In some embodiments said codewords are variable length codewords.

In some embodiments said codewords are based on arithmetic coding.

In the method according to the second embodiment of the invention the set of operations may comprise a set of different prediction modes, each prediction mode representing a prediction directionality.

In the method according to the second embodiment of the invention the set of operations may comprise a set of different transform types.

In some embodiments said transform types are for prediction error coding.

According to a third embodiment there is provided a computer readable storage medium stored with code thereon for use by an apparatus, which when executed by a processor, causes the apparatus to perform:

determining one or more subsets of a set of operations;

selecting an operation among the operations within said subset of operations; and

providing an indication on the subset and on the selected operation.

In some embodiments, when said code is executed by the processor, it may further cause the apparatus to assign an alphabet of codewords for each subset, and to use a codeword of the alphabet assigned to the selected subset as said indication on the selected operation.

In some embodiments said codewords are variable length codewords.

In some embodiments said codewords are based on arithmetic coding.

According to a fourth embodiment there is provided at least one processor and at least one memory, said at least one memory stored with code thereon, which when executed by said at least one processor, causes an apparatus to perform:

determining one or more subsets of a set of operations;

selecting an operation among the operations within said subset of operations; and

providing an indication on the subset and on the selected operation.

An apparatus according to a fifth embodiment comprises:

one or more subsets of a set of operations;

an input for receiving a subset indication indicative of a selected subset among said one or more subsets and for receiving an operation indication indicative of an operation selected among operations within said selected subset; and

a selector for selecting an operation on the basis of said operation indication.

In some embodiments each subset includes a different number of operations, wherein said selector is configured for using the number of operations included in the subset to select said operation.

The apparatus of the fifth embodiment may further comprise an alphabet of codewords assigned for each subset, wherein said selector is configured for using a received codeword and the alphabet assigned to the selected subset to select said operation.

In some embodiments said codewords are variable length codewords.

In some embodiments said codewords are based on arithmetic coding.

In the apparatus of the fifth embodiment of the invention the set of operations may comprise a set of different prediction modes, each prediction mode representing a prediction directionality.

In the apparatus of the fifth embodiment of the invention the set of operations may comprise a set of different transform types.

In some embodiments said transform types are for prediction error coding.

A method according to a sixth embodiment comprises:

determining one or more subsets of a set of operations;

receiving a subset indication indicative of a selected subset among said one or more subsets and for receiving an operation indication indicative of an operation selected among operations within said selected subset; and

selecting an operation on the basis of said operation indication.

In some embodiments of the method each subset includes a different number of operations, wherein the method comprises using the number of operations included in the subset as said indication on the subset.

The method according to the sixth embodiment may further comprise assigning an alphabet of codewords for each subset, and using a received codeword and the alphabet assigned to the selected subset to select said operation.

In some embodiments said codewords are variable length codewords.

In some embodiments said codewords are based on arithmetic coding.

In the method according to the sixth embodiment of the invention the set of operations may comprise a set of different prediction modes, each prediction mode representing a prediction directionality.

In the method according to the sixth embodiment of the invention the set of operations may comprise a set of different transform types.

In some embodiments said transform types are for prediction error coding.

According to a seventh embodiment there is provided a computer readable storage medium stored with code thereon for use by an apparatus, which when executed by a processor, causes the apparatus to perform:

determining one or more subsets of a set of operations;

receiving a subset indication indicative of a selected subset among said one or more subsets and for receiving an operation indication indicative of an operation selected among operations within said selected subset; and

selecting an operation on the basis of said operation indication.

According to an eighth embodiment there is provided at least one processor and at least one memory, said at least one memory stored with code thereon, which when executed by said at least one processor, causes an apparatus to perform:

determining one or more subsets of a set of operations;

receiving a subset indication indicative of a selected subset among said one or more subsets and for receiving an operation indication indicative of an operation selected among operations within said selected subset; and

selecting an operation on the basis of said operation indication.

An encoder according to a ninth embodiment comprises:

one or more subsets of a set of operations;

a selector configured for selecting an operation among the operations within said subset of operations; and

an indication constructor configured for providing an indication on the subset and on the selected operation.

A decoder according to a tenth embodiment comprises:

one or more subsets of a set of operations;

an input for receiving a subset indication indicative of a selected subset among said one or more subsets and for receiving an operation indication indicative of an operation selected among operations within said selected subset; and

a selector for selecting an operation on the basis of said operation indication.

An apparatus according to an eleventh embodiment comprises:

means for defining one or more subsets of a set of operations;

means for selecting an operation among the operations within said subset of operations; and

means for providing an indication on the subset and on the selected operation.

An apparatus according to a twelfth embodiment comprises:

means for defining one or more subsets of a set of operations;

means for receiving a subset indication indicative of a selected subset among said one or more subsets and for receiving an operation indication indicative of an operation selected among operations within said selected subset; and

means for selecting an operation on the basis of said operation indication.

An apparatus according to a thirteenth embodiment comprises:

one or more subsets of prediction modes, each prediction mode representing a directionality information for prediction;

a selector configured for selecting a prediction mode among the prediction modes within said subset of prediction modes; and

an indication constructor configured for providing a subset indication indicative of the subset and a prediction mode indication indicative of the selected prediction mode.

An apparatus according to a fourteenth embodiment comprises:

one or more subsets of prediction modes, each prediction mode representing a directionality information for prediction;

an input for receiving a subset indication indicative of a selected subset among said one or more subsets and for receiving a prediction mode indication indicative of a prediction mode selected among prediction modes within said selected subset; and

a selector for selecting an operation on the basis of said prediction mode indication.

We claim:

1. An apparatus comprising:
one or more subsets of a set of operations;
a selector configured for selecting an operation among the operations within said subset of operations; and
an indication constructor configured for providing an indication on the subset and on the selected operation.

2. The apparatus according to claim 1, wherein each subset includes a different number of operations, wherein said indication constructor is configured for providing the number of operations included in the subset as said indication on the subset.

3. The apparatus according to claim 1, wherein the indication constructor is configured for using a codeword of the alphabet assigned to the selected subset as said indication on the selected operation.

4. The apparatus according to claim 1, wherein the set of operations comprises a set of different prediction modes.

5. The apparatus according to claim 4, wherein at least one prediction mode represents an intra prediction directionality.

6. The apparatus according to claim 1, wherein the set of operations comprises a set of different transform types.

7. A method comprising:
determining one or more subsets of a set of operations;
selecting an operation among the operations within said subset of operations; and
providing an indication on the subset and on the selected operation.

8. The method according to claim 7, wherein each subset includes a different number of operations, wherein the method comprises providing the number of operations included in the subset as said indication on the subset.

9. The method according to claim 7 further comprising assigning an alphabet of codewords for each subset, and using a codeword of the alphabet assigned to the selected subset as said indication on the selected operation.

10. The method according to claim 7, wherein the set of operations comprises a set of different prediction modes.

11. The method according to claim 8, wherein at least one prediction mode represents an intra prediction directionality.

12. The method according to claim 7, wherein the set of operations comprises a set of different transform types.

13. A computer readable storage medium stored with code thereon for use by an apparatus, which when executed by a processor, causes the apparatus to perform:
determining one or more subsets of a set of operations;
selecting an operation among the operations within said subset of operations; and
providing an indication on the subset and on the selected operation.

14. The computer readable storage medium according to claim 13, wherein when said code is executed by the processor, it further causes the apparatus to assign an alphabet of codewords for each subset, and to use a codeword of the alphabet assigned to the selected subset as said indication on the selected operation.

15. An apparatus comprising:
one or more subsets of a set of operations;
an input for receiving a subset indication indicative of a selected subset among said one or more subsets and for receiving an operation indication indicative of an operation selected among operations within said selected subset; and
a selector for selecting an operation on the basis of said operation indication.

16. The apparatus according to claim 15, wherein each subset includes a different number of operations, wherein said selector is configured for using the number of operations included in the subset to select said operation.

17. The apparatus according to claim 15 further comprising an alphabet of codewords assigned for each subset, wherein said selector is configured for using a received codeword and the alphabet assigned to the selected subset to select said operation.

18. The apparatus according to claim 15, wherein the set of operations comprises a set of different prediction modes.

19. The method according to claim 18, wherein at least one prediction mode represents an intra prediction directionality.

20. The apparatus according to claim 15, wherein the set of operations comprises a set of different transform types.

21. A method comprising:
determining one or more subsets of a set of operations;
receiving a subset indication indicative of a selected subset among said one or more subsets and for receiving an operation indication indicative of an operation selected among operations within said selected subset; and
selecting an operation on the basis of said operation indication.

22. The method according to claim 21, wherein each subset includes a different number of operations, wherein the method comprises using the number of operations included in the subset as said indication on the subset.

23. The method according to claim 21 further comprising assigning an alphabet of codewords for each subset, and using a received codeword and the alphabet assigned to the selected subset to select said operation.

24. The method according to claim 21, wherein the set of operations comprises a set of different prediction modes.

25. The method according to claim 24, wherein at least one prediction mode represents an intra prediction directionality.

26. The method according to claim 21, wherein the set of operations comprises a set of different transform types.

27. A computer readable storage medium stored with code thereon for use by an apparatus, which when executed by a processor, causes the apparatus to perform:
determining one or more subsets of a set of operations;
receiving a subset indication indicative of a selected subset among said one or more subsets and for receiving an operation indication indicative of an operation selected among operations within said selected subset; and
selecting an operation on the basis of said operation indication.
